(19) United States
(12) Patent Application Publication
(10) Pub. No.: US 2012/0023517 A1
(43) Pub. Date: Jan. 26, 2012

(54) Method and System for Measuring an Internet Protocol Television Channel Zapping Delay

(75) Inventors: Yin-Hsu Hsu, Hsinchu (TW); Tsung-Han Tsai, Hsinchu (TW); Ya-Ting Tsai, Hsinchu (TW)

(73) Assignee: Gemtek Technology Co., Ltd., Hsinchu (TW)

(21) Appl. No.: 12/842,863

(22) Filed: Jul. 23, 2010

(51) Int. Cl. H04H 60/29; H04L 12/26

(52) U.S. Cl. 725/14; 370/252

(57) ABSTRACT

A method for measuring an Internet Protocol Television (IPTV) channel zapping delay to be implemented using a system that includes a scheduling unit, a remote controller, a stream providing unit, a set-top box, and a packet analyzing unit, said method comprising: a) configuring the scheduling unit to control the remote controller to transmit a channel change signal to the set-top box, whereby the set-top box initiates communication of a plurality of packets with the stream providing unit; b) configuring the packet analyzing unit to capture the packets communicated between the set-top box and the stream providing unit; and c) configuring the packet analyzing unit to compute an IPTV channel zapping delay corresponding to the channel change signal on the basis of the packets captured in step b). A system for measuring an IPTV channel zapping delay is also disclosed.

### BACKGROUND OF THE INVENTION

1. Field of the Invention

This invention relates to a method and system for measuring a quality of experience (QoE) factor in an Internet Protocol Television (IPTV) system, more particularly to a method, a system, and a packet analyzing unit for measuring an IPTV channel zapping delay.

2. Description of the Related Art

IPTV services are expected to yield additional profits for Communication Service Providers (CSP) and drive increased competition in the TV industry. QoE describes how well an IPTV service satisfies customer expectations. A key QoE metric of an IPTV system is how quickly end users can change IPTV channels, often referred to as “IPTV channel zapping delay.” At present, the assessment of IPTV channel zapping delay is subjective and inaccurate due to the fact that measurements are performed manually. Hence, there is the need for an automatic test methodology for accurately and objectively obtaining IPTV channel zapping delay.

### SUMMARY OF THE INVENTION

Therefore, the object of the present invention is to provide a method, a system, and a packet analyzing unit for measuring an IPTV channel zapping delay.

According to one aspect of the present invention, there is provided a method for measuring an IPTV channel zapping delay to be implemented using a system that includes a scheduling unit, a remote controller associated with the scheduling unit, a stream providing unit, a set-top box controlled by the remote controller and capable of communicating with the stream providing unit, and a packet analyzing unit capable of capturing and analyzing packets transmitted between the set-top box and the stream providing unit. The method comprises: a) configuring the scheduling unit to control the remote controller to transmit a channel change signal to the set-top box, whereby the set-top box initiates communication of a plurality of packets with the stream providing unit in response to receipt of the channel change signal; b) configuring the packet analyzing unit to capture the packets communicated between the set-top box and the stream providing unit; and c) configuring the packet analyzing unit to compute an IPTV channel zapping delay corresponding to the channel change signal on the basis of the packets captured in step b).

According to another aspect of the present invention, there is provided a system for measuring an IPTV channel zapping delay of a set-top box controlled by a remote controller and capable of communicating with a stream providing unit. The system comprises: a scheduling unit configured to control the remote controller to transmit a channel change signal to the set-top box, whereby the set-top box initiates communication of a plurality of packets with the stream providing unit in response to receipt of the channel change signal; and a packet analyzing unit including a monitoring module and a calculating module, the monitoring module being configured to capture the packets communicated between the set-top box and the stream providing unit, the calculating module being configured to compute an IPTV channel zapping delay corresponding to the channel change signal on the basis of the packets captured by the monitoring module.

According to another aspect of the present invention, there is provided a packet analyzing unit for measuring an IPTV channel zapping delay to be implemented in a system that includes a stream providing unit, and a set-top box capable of communicating with the stream providing unit. The packet analyzing unit comprises: a monitoring module configured to capture a plurality of packets communicated between the set-top box and the stream providing unit; and a calculating module configured to compute an IPTV channel zapping delay on the basis of the packets captured by the monitoring module. The calculating module obtains a first time corresponding to when an IGMP leave packet is transmitted by the set-top box, obtains a second time corresponding to when a first PAT packet of a transport stream is received by the set-top box subsequent to when the IGMP leave packet is transmitted by the set-top box, and computes a difference between the first time and the second time to obtain the IPTV channel delay.

### BRIEF DESCRIPTION OF THE DRAWINGS

In drawings which illustrate an embodiment of the invention,

FIG. 1 is a block diagram of the preferred embodiment of a system for measuring an IPTV channel zapping delay according to the present invention, illustrating the preferred embodiment in a state ready to measure the IPTV channel zapping delay in an IPTV system;

FIG. 2 is a flowchart to illustrate the preferred embodiment of a method for measuring an IPTV channel zapping delay according to the present invention; and

FIG. 3 is a schematic view to illustrate an IPTV channel zapping delay and a time interval.

### DETAILED DESCRIPTION OF THE PREFERRED EMBODIMENT

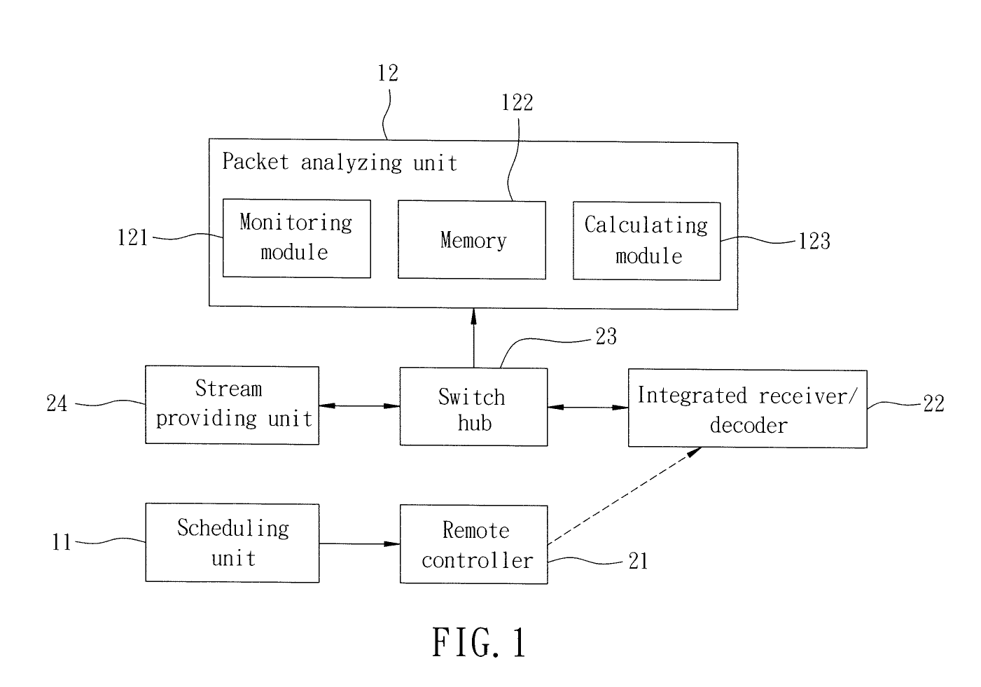

FIG. 1 illustrates the preferred embodiment of a system for measuring an IPTV channel zapping delay, in which the preferred embodiment is shown in a state ready to measure the IPTV channel zapping delay in an IPTV system.

The system of the preferred embodiment includes a scheduling unit 11 and a packet analyzing unit 12, and the IPTV system includes a remote controller 21, a set-top box 22, a switch hub 23, and a stream providing unit 24.

The remote controller 21 is an infrared (IR) remote controller that is associated with the scheduling unit 11 and is controlled by the scheduling unit 11. The set-top box 22 is controlled by the remote controller 21 and is capable of communicating with the stream providing unit 24 via the switch hub 23. The switch hub 23 supports an Internet Group Management Protocol (IGMP), such as IGMPv2/v3. The stream providing unit 24 is a video server for continuously generating and delivering multicast MPEG-TS (Moving Picture Experts Group transport stream) streams.

The scheduling unit 11 is configured to control the remote controller 21 to transmit at least one channel change signal to the set-top box 22 according to a predefined schedule. The predefined schedule is programmable by testers and includes at least one action data. In this embodiment, the predefined schedule includes a sequence of action data, each action data has a channel indication and a time interval. In this embodiment, the scheduling unit 11 controls the remote controller 21 to transmit a sequence of channel change signals to the set-top box 22 according to the predefined schedule. That is, in this embodiment, the scheduling unit 11 controls the remote controller 21 to transmit each channel change signal according to the channel indication of a respective one of the action data, and controls the remote controller 21 to transmit the next channel change signal according to the time interval of the respective one of the action data.

The packet analyzing unit 12 includes a monitoring module 121, a memory 122, and a calculating module 123. The monitoring module 121 is configured to capture a plurality of packets communicated between the set-top box 22 and the stream providing unit 24. The packets captured by the monitoring module 121 are buffered in the memory 122. The calculating module 123 is configured to compute at least one channel zapping delay corresponding to the channel change signal on the basis of the packets captured by the monitoring module 121. In this embodiment, the monitoring module 121 is realized using existing packet monitoring software, such as Wireshark®.

In this embodiment, the functions and operations of the scheduling unit 11 can be performed by a processor of a computer (not shown) coupled with the remote controller 21. Moreover, in this embodiment, the functions and operations of the packet analyzing unit 12 can be performed by a processor of another computer (not shown) coupled with the switch hub 23.

The preferred embodiment of a method for measuring an IPTV channel zapping delay according to the present invention will now be described.

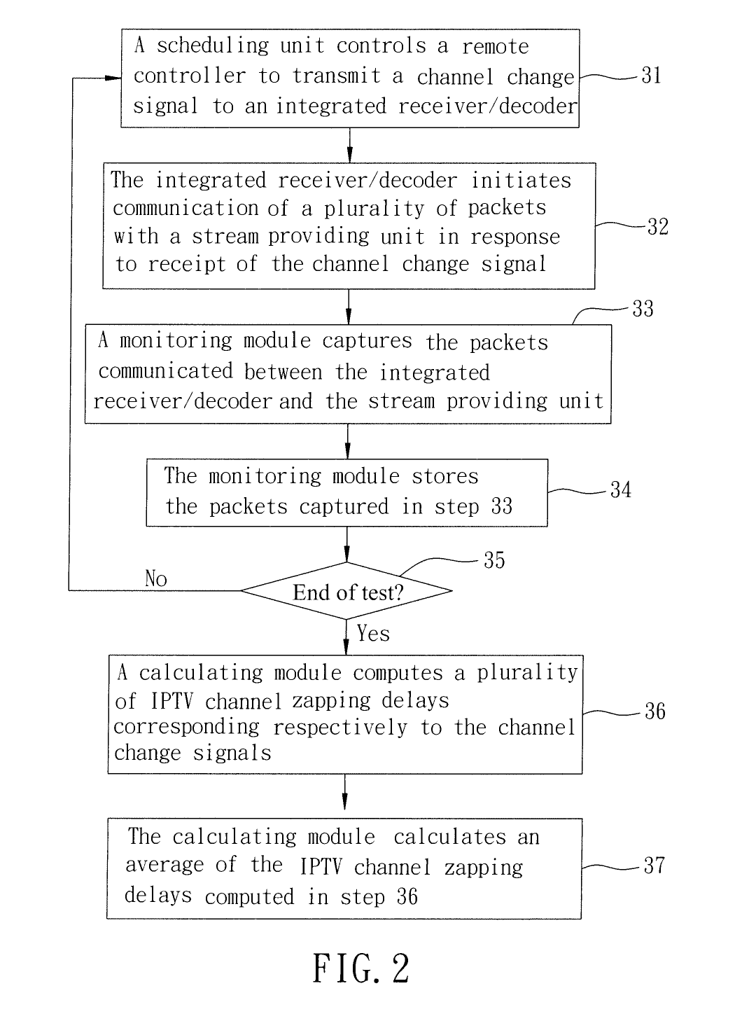

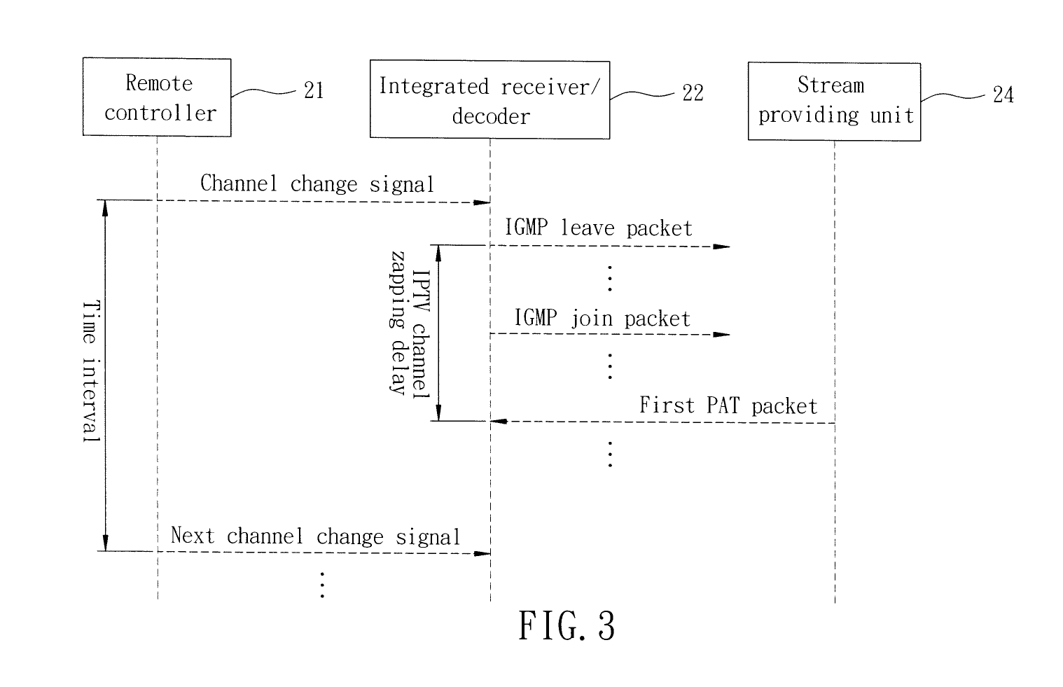

Referring to FIGS. 2 and 3, in combination with FIG. 1, the method according to the preferred embodiment of the present invention includes the steps as outlined below.

Before performing the following steps, a predefined schedule including a sequence of action data is provided by a tester. Each action data has a channel indication and a time interval.

At step 31, the scheduling unit 11 controls the remote controller 21 to transmit a channel zapping change to the set-top box 22 according to the channel indication of a respective one of the action data.

At step 32, the set-top box 22 initiates communication of a plurality of packets with the stream providing unit 24 via the switch hub 23 in response to receipt of the channel change signal.

At step 33, the monitoring module 121 of the packet analyzing unit 12 captures the packets communicated between the set-top box 22 and the stream providing unit 24.

At step 34, the monitoring module 121 of the packet analyzing unit 12 stores the packets captured in step 33 in the memory 122 of the packet analyzing unit 12. The packets captured in step 33 at least include an IGMP leave packet, an IGMP join packet, and a Program Association Table (PAT) packet of an MPEG-TS (see FIG. 3) streams.

At step 35, the scheduling unit 11 determines whether control has been performed such that the remote controller 21 has transmitted a sequence of channel change signals related respectively to each channel indication of the action data. If so, the flow continues to step 36. Otherwise, the flow returns to step 31, i.e., the scheduling unit 11 controls the remote controller 21 to transmit the next channel change signal to the set-top box 22 according to the time interval of the respective one of the action data. At step 36, the calculating module 123 of the packet analyzing unit 12 computes a plurality of IPTV channel zapping delays corresponding respectively to the channel change signals on the basis of the packets stored in step 34. With reference to FIG. 3, in this embodiment, for each of the channel change signals, the calculating module 123 obtains a first time corresponding to when the IGMP leave packet is transmitted by the set-top box 22 in response to receipt of the channel change signal from the remote controller 21, obtains a second time corresponding to when the first PAT packet of the MPEG-TS streams is received by the set-top box 22 subsequent to when the IGMP leave packet and the IGMP join packet are transmitted by the set-top box 22, and computes a difference between the first time and the second time to obtain the corresponding IPTV channel delay. The calculating module 123 of the packet analyzing unit 12 repeats this to compute said plurality of IPTV channel zapping delays corresponding respectively to the channel change signals.

At step 37, the calculating module 123 of the packet analyzing unit 12 calculates an average of the IPTV channel zapping delays computed in step 36. The average of the IPTV channel zapping delays is referred to as the “IPTV channel zapping delay” of the IPTV system.

In sum, the method and the system of the preferred embodiment automatically obtains a metric that is accurate and objective, and that is a good measure of an important QoE factor in an IPTV system, namely, the IPTV channel zapping delay thereof.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

What is claimed is:

1. A method for measuring an Internet Protocol Television (IPTV) channel zapping delay to be implemented using a system that includes a scheduling unit, a remote controller associated with the scheduling unit, a stream providing unit, a set-top box controlled by the remote controller and capable of communicating with the stream providing unit, and a packet analyzing unit capable of capturing and analyzing packets transmitted between the set-top box and the stream providing unit, said method comprising:
a) configuring the scheduling unit to control the remote controller to transmit a channel change signal to the set-top box, whereby the set-top box initiates communication of a plurality of packets with the stream providing unit in response to receipt of the channel change signal;
b) configuring the packet analyzing unit to capture the packets communicated between the set-top box and the stream providing unit; and
c) configuring the packet analyzing unit to compute an IPTV channel zapping delay corresponding to the channel change signal on the basis of the packets captured in step b).

2. The method of claim 1, wherein, in step c), the packet analyzing unit is configured to perform the following sub-steps to compute the IPTV channel delay:
c-1) obtaining a first time corresponding to when an Internet Group Management Protocol (IGMP) leave packet is transmitted by the set-top box in response to receipt of the channel change signal from the remote controller;
c-2) obtaining a second time corresponding to when a first Program Association Table (PAT) packet of a transport stream is received by the set-top box subsequent to when the IGMP leave packet is transmitted by the set-top box; and
c-3) computing a difference between the first time and the second time to obtain the IPTV channel delay.

3. The method of claim 1, wherein:
in step a), the scheduling unit is configured to control the remote controller to transmit a sequence of channel change signals to the set-top box according to a predefined schedule, whereby the set-top box initiates communication of a plurality of packets with the stream providing unit in response to receipt of each of the channel change signals; and
in step c), the packet analyzing unit is configured to compute a plurality of IPTV channel zapping delays corresponding respectively to the channel change signals on the basis of the packets captured in step b);
said method further comprising the following step:
d) configuring the packet analyzing unit to calculate an average of the IPTV channel zapping delays obtained in step c).

4. The method of claim 3, wherein the predefined schedule in step a) includes a sequence of action data, each action data having a channel indication and a time interval, the scheduling unit being configured to control the remote controller to transmit each channel change signal according to the channel indication of a respective one of the action data, and to control the remote controller to transmit the next channel change signal according to the time interval of the respective one of the action data.

5. A system for measuring an IPTV channel zapping delay of a set-top box controlled by a remote controller and capable of communicating with a stream providing unit, said system comprising:
a scheduling unit configured to control the remote controller to transmit a channel change signal to the set-top box, whereby the set-top box initiates communication of a plurality of packets with the stream providing unit in response to receipt of the channel change signal; and
a packet analyzing unit including a monitoring module and a calculating module, said monitoring module being configured to capture the packets communicated between the set-top box and the stream providing unit, said calculating module being configured to compute an IPTV channel zapping delay corresponding to the channel change signal on the basis of the packets captured by said monitoring module.

6. The system of claim 5, wherein said calculating module of said packet analyzing unit is configured to obtain a first time corresponding to when an IGMP leave packet is transmitted by the set-top box in response to receipt of the channel change signal from the remote controller, to obtain a second time corresponding to when a first PAT packet of a transport stream is received by the set-top box subsequent to when the IGMP leave packet is transmitted by the set-top box, and to compute a difference between the first time and the second time to obtain the IPTV channel delay.

7. The system of claim 5, wherein said scheduling unit is configured to control the remote controller to transmit a sequence of channel change signals to the set-top box according to a predefined schedule, whereby the set-top box initiates communication of a plurality of packets with the stream providing unit in response to receipt of each of the channel change signals, said calculating module of said packet analyzing unit being configured to compute a plurality of IPTV channel zapping delays corresponding respectively to the channel change signals on the basis of the packets captured by said monitoring module of said packet analyzing unit, and to calculate an average of the IPTV channel zapping delays.

8. The system of claim 7, wherein the predefined schedule includes a sequence of action data, each action data having a channel indication and a time interval, said scheduling unit being configured to control the remote controller to transmit each channel change signal according to the channel indication of a respective one of the action data, and to control the remote controller to transmit the next channel change signal according to the time interval of the respective one of the action data.

9. A packet analyzing unit for measuring an IPTV channel zapping delay to be implemented in a system that includes a stream providing unit, and a set-top box capable of communicating with the stream providing unit, said packet analyzing unit comprising:
a monitoring module configured to capture a plurality of packets communicated between the set-top box and the stream providing unit; and
a calculating module configured to compute an IPTV channel zapping delay on the basis of the packets captured by said monitoring module;
wherein said calculating module obtains a first time corresponding to when an IGMP leave packet is transmitted by the set-top box, obtains a second time corresponding to when a first PAT packet of a transport stream is received by the set-top box subsequent to when the IGMP leave packet is transmitted by the set-top box, and computes a difference between the first time and the second time to obtain the IPTV channel delay.
